(19) United States
(12) Patent Application Publication
(10) Pub. No.: US 2022/0040699 A1
(43) Pub. Date: Feb. 10, 2022

(54) TEMPERATURE PROFILE ENCODING FOR DIAGNOSTIC TESTS

(71) Applicant: Detect, Inc., Guilford, CT (US)

(72) Inventors: Jonathan M. Rothberg, Miami Beach, FL (US); Benjamin Rosenbluth, Hamden, CT (US); Todd Roswech, Ivoryton, CT (US)

(73) Assignee: Detect, Inc., Guilford, CT (US)

(21) Appl. No.: 17/397,517

(22) Filed: Aug. 9, 2021

Related U.S. Application Data
(60) Provisional application No. 63/063,931, filed on Aug. 10, 2020.

(51) Int. Cl. B01L 7/00; B01L 3/00

(52) U.S. Cl. CPC B01L 7/52; B01L 3/50825; B01L 2300/021; B01L 2300/025; B01L 2200/147; B01L 2300/0816; B01L 2300/18; B01L 2300/0663; B01L 2300/042; B01L 2300/023

(57) ABSTRACT

Provided herein, in some embodiments, are rapid diagnostic tests to detect one or more target nucleic acid sequences (e.g., a nucleic acid sequence of one or more pathogens). In some embodiments, the pathogens are viral, bacterial, fungal, parasitic, or protozoan pathogens, such as SARS-CoV-2 or an influenza virus. In one embodiment, a diagnostic system is provided comprising a control device configured to control one or more parameters and/or actions of a diagnostic test, and a test kit component comprising a physical encoding of control information for the control device. In one embodiment, the control device is configured to receive the control information of the physical encoding and perform one or more actions based at least in part on the control information. In one embodiment, the control device can control one or more temperatures at which a biological sample is to be processed as part of the diagnostic test.

### RELATED APPLICATIONS

This application claims priority under 35 U.S.C. § 119(e) to U.S. Provisional Application Ser. No. 63/063,931, titled “TEMPERATURE PROFILE ENCODING FOR DIAGNOSTIC TESTS,” filed on Aug. 10, 2020, which is herein incorporated by reference in its entirety.

### FIELD

The present invention generally relates to diagnostic devices, systems, and methods for detecting the presence of a target nucleic acid sequence.

### BACKGROUND

The ability to rapidly diagnose diseases—particularly highly infectious diseases—is critical to preserving human health. As one example, the high level of contagiousness, the high mortality rate, and the lack of a treatment or vaccine for the coronavirus disease 2019 (COVID-19) have resulted in a pandemic that has already infected millions and killed hundreds of thousands of people. The existence of rapid, accurate COVID-19 diagnostic tests could allow infected individuals to be quickly identified and isolated, which could assist with containment of the disease. In the absence of such diagnostic tests, COVID-19 may continue to spread unchecked throughout communities.

### SUMMARY

Provided herein are a number of diagnostic tests useful for detecting target nucleic acid sequences. The tests, as described herein, are able to be performed in a point-of-care (POC) setting or home setting without specialized equipment.

Therefore, in some aspects, the disclosure provides a test kit system comprising a test kit configured to rapidly detect presence of a target nucleic acid in a human sample, including a test kit component, and a control device configured to control at least one parameter of the test kit component.

In some aspects, the disclosure provides a diagnostic system comprising a temperature control device configured to control one or more temperatures at which a biological sample is to be processed as part of a diagnostic test, and a consumable comprising a physical encoding of control information for the temperature control device, wherein the temperature control device is configured to receive the control information of the physical encoding and perform one or more actions based at least in part on the control information.

### BRIEF DESCRIPTION OF THE DRAWINGS

FIG. 1A is a block diagram depicting a diagnostic system including a control device and a test element, according to some embodiments;

FIG. 1B is a flow diagram depicting an illustrative method for using the system of FIG. 1A, according to some embodiments;

FIG. 2 is a graph illustrating a temperature profile for a recombinase polymerase amplification—like process, including estimated watt-hour requirements and power, according to some embodiments;

FIG. 3 is a graph illustrating a temperature profile for a recombinase polymerase amplification—like process;

FIG. 4 shows, according to some embodiments, a detection component comprising a “chimney”;

FIG. 5 shows diagnostic kits comprising a sample-collecting component, a reaction tube, a detection component, and a temperature control device, according to some embodiments;

FIG. 6 shows, according to some embodiments, a cartridge comprising a first reservoir, a second reservoir, a third reservoir, a vent path, a detection region, and a pumping tool;

FIG. 7 shows, according to some embodiments, a diagnostic kit comprising a sample-collecting component and a cartridge;

FIG. 8 shows, according to some embodiments, a diagnostic device comprising a plurality of blister packs; and

FIG. 9 depicts an illustrative implementation of a computer system that may be used in connection with some embodiments of the technology described herein.

### DETAILED DESCRIPTION

The present disclosure provides diagnostic devices, systems, and methods for rapidly and in a home environment detecting one or more target nucleic acid sequences (e.g., a nucleic acid sequence of a pathogen, such as SARS-CoV-2 or an influenza virus). A diagnostic system, as described herein, may be self-administrable and comprise a sample-collecting component (e.g., a swab) and a diagnostic device. In some embodiments, the diagnostic system may comprise one or more consumables (e.g., a test tube, a test tube cap, a swab, a card, a label) which may be discarded after use or configured for multiple uses with the diagnostic device. The diagnostic device may comprise a cartridge, a blister pack, and/or a “chimney” detection device, according to some embodiments. In some cases, the diagnostic device comprises a detection component (e.g., a lateral flow assay strip, a colorimetric assay), results of which are self-readable, or automatically read by a computer vision system (e.g., running one or more computer vision algorithms). In certain embodiments, the diagnostic device further comprises one or more reagents (e.g., lysis reagents, nucleic acid amplification reagents, CRISPR/Cas detection reagents). In certain other embodiments, the diagnostic system separately includes one or more reaction tubes comprising the one or more reagents. The diagnostic device may comprise an integrated temperature control device (e.g., a heater, a cooling device, or any other suitable temperature control device), or the diagnostic system may comprise a separate temperature control device (e.g., a heater, a cooling device, or any other suitable temperature control device). The isothermal amplification technique employed in some embodiments yields not only fast but very accurate results.

### I. Control Information Encoding Techniques

The inventors have recognized and appreciated that performing diagnostic tests according to the techniques described herein may require performing one or more actions, such as heating and/or cooling the sample being tested to one or more different temperatures (e.g., to activate biology of the sample), providing security information (e.g., an identify of a consumable, a secure token, etc.), providing one or more indicators (e.g., lights and/or sounds), and/or the like. For example, a diagnostic system according to the techniques developed by the inventors may comprise a temperature control device configured to heat and/or cool one or more components of the diagnostic system (e.g., fluidic contents of reaction tube(s) or reservoir(s), such as one or more samples) during the course of a diagnostic test. In some embodiments, the temperature control device may be configured to heat and/or cool one or more components of the diagnostic system to multiple different temperatures for and/or at multiple different times. A set of temperature(s) and/or time(s) representing heating and/or cooling actions to be carried out by a temperature control device may be referred to herein as a temperature profile or a heating profile.

The inventors have recognized and appreciated that different diagnostic tests carried out according to the techniques described herein may, in some cases, require different actions, such as performing different temperature profiles, providing different indicators, authenticating different security information, and/or the like. Although some actions and/or variables associated with those actions (e.g., time, temperature, volume, color, number of repetitions of an action, etc.) may be pre-programmed on the device, it can be desirable to provide the actions and/or variables associated with actions from an external source. For example, while one or more temperature profiles may be pre-programmed on the temperature control device, the inventors have recognized and appreciated that, in some embodiments, it may be advantageous to receive the temperature profile from a source external to the temperature control device. For example, the inventors have recognized that it may be desirable provide the temperature control device with one or more new temperature profile(s) other than any temperature profile(s) with which the temperature control device was pre-programmed. By providing new temperature profile(s) to the temperature control device, the diagnostic system as a whole may be updated to perform new diagnostic tests, substantially increasing the variety of tests that can be performed. The ability to receive temperature profile(s) at the temperature control device may further provide the ability to change (e.g., update or fix) one or more temperature profile(s) pre-programmed on the temperature control device. For example, it may be desirable to replace an older version of a temperature profile with a newer version of the temperature profile (e.g., if the newer version provides an improvement in testing accuracy, speed, or convenience over the older version).

The inventors have further recognized and appreciated that, in the context of rapid diagnostic testing which may be self-administered, performed in a home environment and/or administered by clinicians with little (if any) training, it may be desirable for the temperature control device to receive a temperature control profile without requiring effort or input from the user of the diagnostic system. This may provide increased convenience for the user, and reduce testing errors. For example, if the user of the diagnostic system is unfamiliar with the operation of the temperature control device, the process of adding/changing temperature profile(s) (e.g., by manually reprogramming the temperature control device, installing a firmware upgrade, or otherwise) may be challenging or susceptible to error. Additionally, the inventors have recognized and appreciated that it may be desirable for one or more temperature profile(s) to be selected and/or executed by the temperature control device without requiring effort or input from the user. This may provide increased convenience for the user, and further reduce testing errors (e.g., by reducing the likelihood that a user selects and/or executes an incorrect temperature profile).

Recognizing the foregoing, the inventors have developed techniques for remotely controlling one or more actions and/or parameters of a diagnostic test. In some embodiments, the techniques provide for a diagnostic system that includes a component that is configured to remotely control an action, parameter and/or parameters of the test kit, such as heating, cooling, or other actions and/or related parameter(s). In some embodiments, the techniques provide for a diagnostic system in which a temperature control device receives control information via a physical encoding of the control information in a consumable of the diagnostic. For example, in one embodiment, the control information may represent a temperature profile for the temperature control device, and may be encoded in an RFID tag of a reaction tube of the diagnostic system. Upon receiving the control information (e.g., by activating the RFID tag or otherwise accessing the physical encoding of the control information), the temperature control device may perform one or more actions based at least in part on the control information. For example, the temperature control device may execute, update, or store a temperature profile based on the control information.

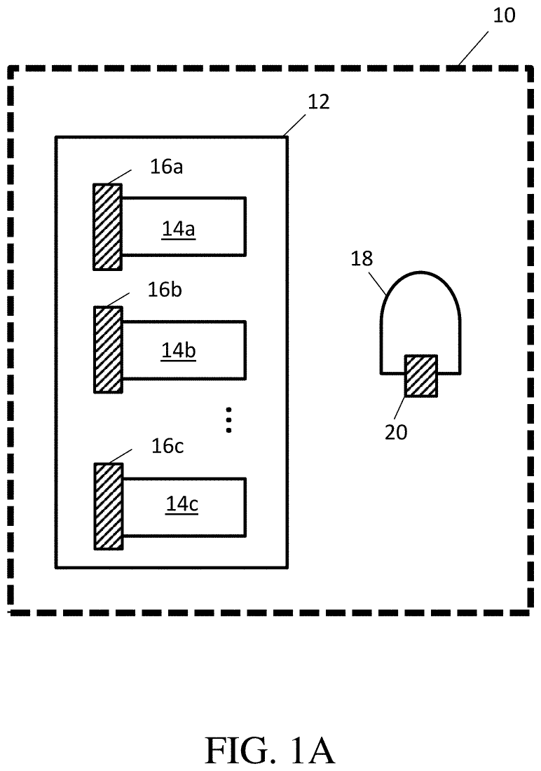

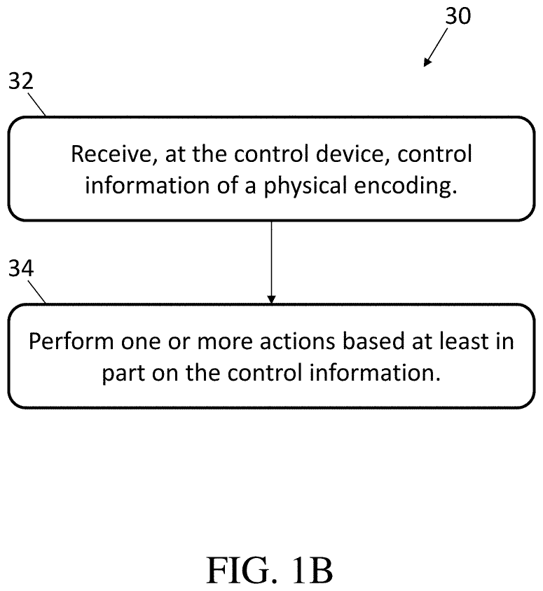

Although some embodiments relate to controlling a temperature control device, it should be appreciated that the techniques described herein at least in connection with FIGS. 1A-B may additionally or alternatively be used to control other elements of a diagnostic system. For example, the techniques described herein may be used to provide control information for any hardware of the diagnostic system (e.g., hardware to control an amount of light applied to a biological sample as part of a diagnostic test; hardware to control application of one or more chemical agents to a biological sample as part of a diagnostic test; hardware to mix, move, or otherwise control the flow of a biological sample as part of a diagnostic test). Regardless of the component of the diagnostic system being controlled, the control information may comprise one or more instructions to be carried out by the component of the diagnostic system, and, in some embodiments, one or more times at which those instructions are to be carried out. In some embodiments, control information may be provided for multiple components of the diagnostic system (e.g., a testing protocol including both temperature control instructions and mixing or auto-pipetting instructions), according to the techniques described herein.

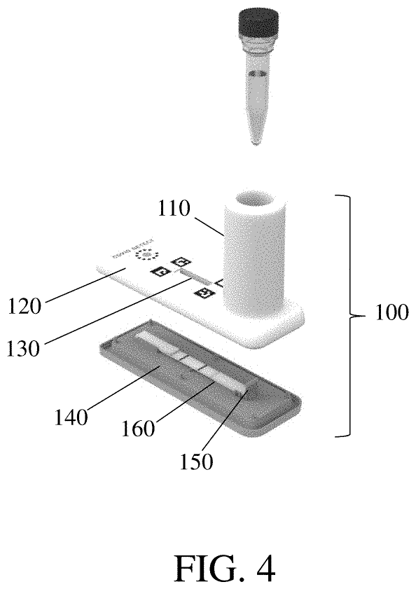

FIG. 1A depicts an exemplary diagnostic system 10 including a control device 12 and a test element 18. The diagnostic system 10 may be a diagnostic system according to any of the embodiments described herein (e.g., as described in connection with any of FIGS. 4-8), and some or all of the elements described herein in connection with diagnostic system 10 may be combined with elements of other diagnostic systems described herein. In some embodiments, the control device 12 is a temperature control device.

The test element 18 can be, for example, a consumable. The consumable may be any consumable as described herein. For example, the consumable may be a reaction tube, a reaction tube cap, a card (e.g., a sheet of paper or plastic included with a diagnostic test kit), a label (e.g., a label adhered to or integrated with a reaction tube or reaction tube cap; a label of a box or other packaging containing a diagnostic test kit; a sticker), a swab, a card, a blister pack, or any other suitable component of the diagnostic system. The consumable may be discarded after use, and/or may be configured for multiple uses. In one embodiment, the consumable may be configured to be inserted into the temperature control device as part of the diagnostic test.

In some embodiments, the control device 12 of diagnostic system 10 may comprise one or more wells. In the illustrated example, control device 12 includes wells 14a, 14b, and 14c. Although three wells are shown in this example, a temperature control device may have fewer wells (e.g., two wells, one well, no wells) or more wells (e.g., four wells, five wells, more than five wells, etc). In some embodiments, each well of control device 12 may be configured to receive one or more test elements of the diagnostic system 10. For example, each well of control device 12 may be configured to receive a reaction tube or a swab. In the illustrated example, a single test element 18 is shown, but the diagnostic system 10 may include multiple test elements. In some embodiments, multiple wells of the control device 12 may receive test elements, such as in a simultaneous or staggered manner.

As described herein, the control device 12 may be configured to perform one or more actions, such as to control the temperature (e.g., heat and/or cool) the contents of well(s) 14a, 14b, and 14c. In some embodiments, the temperature of some or all of the wells may be controlled together (e.g., with a single heating and/or cooling mechanism for multiple wells). In some embodiments, the temperature of each well may be controlled independently (e.g., with separate heating and/or cooling mechanisms for each well), such that different wells may be heated and/or cooled to different temperatures, or different temperature profiles may be executed for each well. In some embodiments, the control device 12 may comprise one or more processors to control the behavior of the control device 12 (e.g., by controlling one or more components such as heating or cooling mechanisms, lights, speakers, displays, or any other mechanical or electronic components of the control device).

In some embodiments, the control device 12 may further comprise one or more receiving components (e.g., for accessing a physical encoding that stores temperature profile information). A receiving component may be, for example, one or more electrical connectors (e.g., a conductive contact point or probe), an RFID reading component (e.g., an antenna or other suitable circuitry for reading RFID tags), or a wireless connection point (e.g., a Bluetooth or WiFi adapter, or any other suitable wireless access circuitry). In the illustrated example, control device 12 includes three receiving components 16a, 16b, and 16c. Although three receiving components are shown in this example, a control device may have fewer receiving components (e.g., two receiving components, one receiving component, no receiving components) or more receiving components (e.g., four receiving components, five receiving components, more than five receiving components, etc.). In the illustrated example, each receiving component 16a, 16b, 16c is associated with a respective well 14a, 14b, 14c of the control device 12. In some embodiments, a receiving component may be in physical contact or proximity with a respective well. In some embodiments, control device 12 may include one or more receiving components that are not each associated with a respective well. For example, in some embodiments, a receiving component may be associated with multiple wells. In one embodiment, there may be a single receiving component for all the wells.

Regardless of the number or type of the wells and/or receiving components of the control device 12, the wells and the receiving components of the control device 12 may be configured to receive one or more test components such as test component 18. In some embodiments, the test component 18 may comprise a physical encoding 20, wherein information encoded in physical encoding 20 may be accessible using a corresponding receiving component (e.g., 16a, 16b, 16c) of the control device 12. According to some embodiments, the physical encoding 20 may comprise, for example, one or more electrical connectors (e.g., a conductive contact point or probe), an RFID tag (e.g., integrated with or adhered to a cap of a reaction tube, or included as part of a label or card), or a visual encoding (e.g., a printed data matrix code, such as a barcode, QR code, or any other suitable encoding).

The information of physical encoding 20 may be accessible using a corresponding receiving component (e.g., 16a, 16b, 16c) of control device 12 in any suitable manner. For example, if physical encoding 20 comprises one or more electrical connectors, and the receiving component comprises one or more electrical connectors, then the information of the physical encoding 20 may be accessible via physical contact between the electrical connectors. If the physical encoding 20 comprises an RFID tag and the receiving component comprises an RFID reading component, then the information of the physical encoding may be accessible when the RFID reading component activates the RFID tag comprising the physical encoding 20. If the physical encoding 20 comprises a visual encoding (such as a dot matrix code), then the information of the physical encoding may be accessible when the receiving component (e.g., a Bluetooth, WiFi, or other wireless adapter) establishes a connection with an electronic device that has processed the visual encoding (e.g., by capturing and/or processing an image of the dot matrix code). As a result, a wireless connection may be established between a portable electronic device and the temperature control device based on the data matrix code, and the temperature control device may receive the control information via the wireless connection.

Regardless of the nature of the physical encoding 20 and/or the corresponding receiving component, the physical encoding may comprise an encoding of control information (e.g., a temperature profile) for the control device 12.

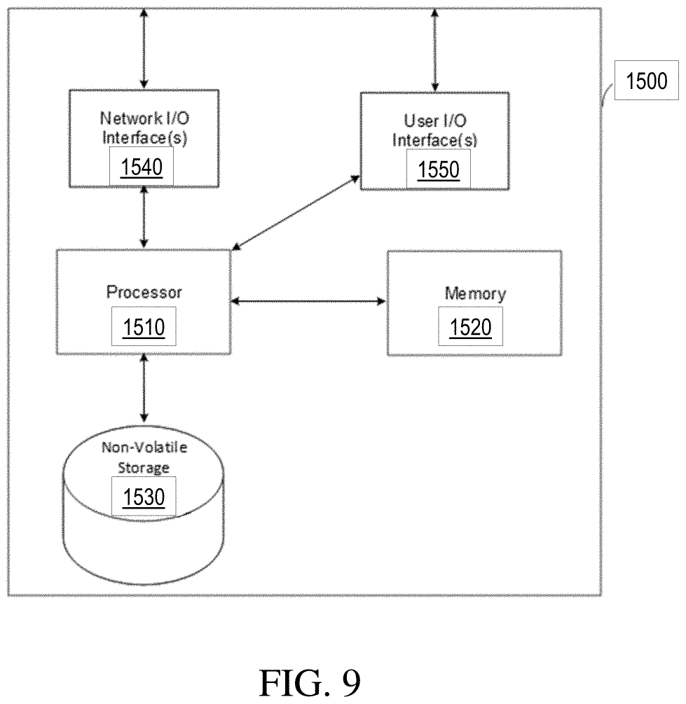

FIG. 1B is a flow diagram depicting an illustrative method 30 for using the system of FIG. 1A, according to some embodiments. In some embodiments, method 30 may be carried out by control circuitry of control device 12. In some embodiments, the control circuitry may comprise one or more processors, as described herein at least with respect to FIG. 9.

Method 30 begins at act 32 with receiving, at control device 12, control information of a physical encoding (e.g., physical encoding 20). As described herein at least with respect to FIG. 1A, the control information may be accessible using a receiving component of control device 12. In some embodiments, the control information may be received by the control device automatically (e.g., when a consumable is received in a well of the temperature control device). In some embodiments, receiving the control information may rely on further user action. For example, if the physical encoding of the consumable is an RFID tag, the user may be directed to place the consumable in contact or proximity with the RFID reading component of the control device. This may comprise, for example, touching a location on the control device with the consumable (e.g., a marked location on the temperature control device, which may be in contact or proximity with the RFID tag reading component). If the physical encoding comprises a visual encoding, such as a dot matrix code, then the user may be directed to use an electronic device (e.g., a portable electronic device, such as a smartphone) to process the visual encoding. For example, the user may need to capture an image of the visual encoding, and/or direct the electronic device to establish a wireless connection (e.g., a Bluetooth or WiFi connection) with the temperature control device based on the processed visual encoding.

Regardless of how it is received, the control information may, in some embodiments, comprise information specifying one or more actions to be performed by the control device (including meta-information such as the quantity or types of actions to be performed, a unique identifier for the control information, etc.). The actions may include temperature control actions (e.g., performing heating and/or cooling, such as with a temperature profile), physical device actions (e.g., activating one or more indicator lights, playing one or more sounds, etc.), or electronic device actions (e.g., storing information, such as one or more temperature profiles, in a storage medium associated with the temperature control device, or performing authentication of security information such as a security token).

In some embodiments, the control information may include information specifying one or more variables associated with the one or more actions. For example, a variable relating to a temperature control action might specify a temperature and a time, which might represent increasing and/or decreasing a temperature, increasing and/or decreasing the temperature for a duration, or increasing and/or decreasing the temperature to set temperature. Variables relating to physical device actions might include a time (e.g., a time at which to activate an indicator light or play a sound), a temperature (e.g., at which to heat or cool), a volume or pitch (e.g., at which to play a sound), a color (e.g., of indicator light to activate), or a number of repetitions (e.g., the number of times to activate an indicator light or play a sound). Accordingly, the control information can specify an action and one or more variables associated with the action.

In some embodiments, the control information may include security information. For example, the security information may comprise information specifying an identity of the consumable (e.g., specifying what kind of diagnostic test the consumable is associated with or specifying an identity of an owner or user of the consumable). The security information may additionally or alternatively include a security token, such as a password. In some embodiments, the security information may be encrypted.

Method 30 proceeds at act 34 with the control device performing one or more actions based at least in part on the control information. In some embodiments, the control device may proceed automatically to act 34 after act 32, without requiring further user input. In some embodiments, the user may provide input (e.g., via a button, dial, or switch on the control device, or via an interface of an electronic device such as a smartphone) in order to advance method 30 from act 32 to act 34.

In one embodiment, the one or more actions performed at act 34 may comprise storing the control information of the physical encoding (e.g., in a storage medium associated with the temperature control device). In one embodiment, the one or more actions performed at act 34 may comprise performing authentication on security information of the control information (e.g., confirming the identity of the consumable and/or diagnostic test, and/or confirming the validity of a security token of the security information). The one or more actions may additionally or alternatively comprise decrypting some or all of the control information.

In one embodiment, the one or more actions may comprise a sequence of actions. In one embodiment, the control device may perform a temperature profile, as described elsewhere herein, based on temperature control actions specified in the control information. For example, the one or more actions may include increasing and/or decreasing a temperature (e.g., at which the biological sample is processed). In some embodiments, the temperature may be increased and/or decreased for a duration of time. In some embodiments, the temperature may be increased and/or decreased to a set temperature. In one embodiment, the control device may control multiple temperatures at which multiple biological samples are to be processed. For example, the multiple biological samples may be configured to be processed simultaneously.

In one embodiment, the one or more actions may include activating an indicator of the control device. The indicator may, for example, be a light and/or a sound.

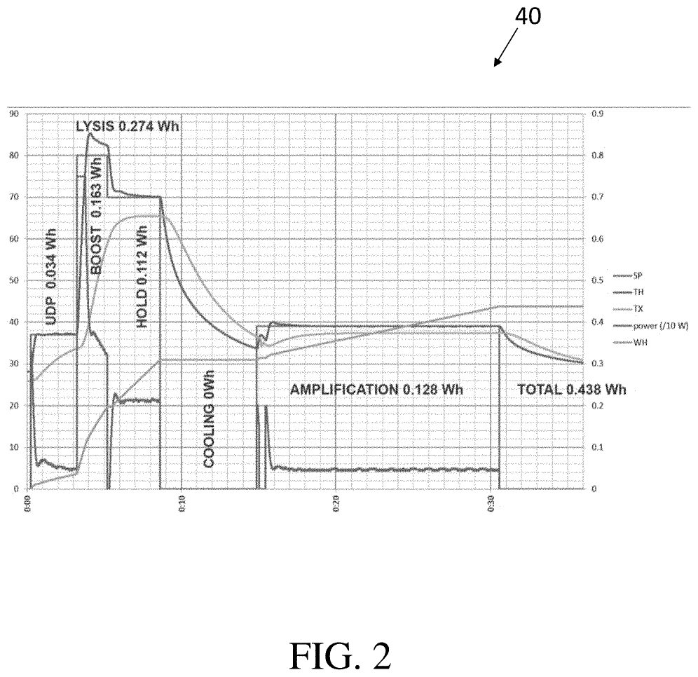

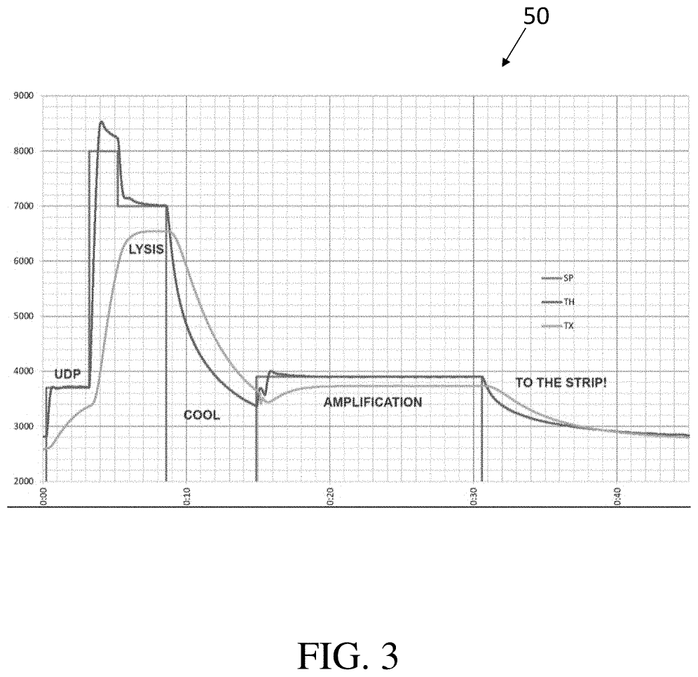

FIG. 2 and FIG. 3 depict exemplary temperature profiles, according to some embodiments. In particular, FIG. 2 is a graph 40 illustrating a temperature profile for a recombinase polymerase amplification—like process, including estimated watt-hour (Wh) requirements and power (/10 W), and FIG. 3 is a graph 50 illustrating a temperature profile for a recombinase polymerase amplification—like process. The graph 40 of FIG. 2 graphs SP, TH, TX, power (/10 W), and WH. The horizontal axis shows Wh, and the left vertical axis shows temperature in degrees Celsius. The graph 50 of FIG. 3 graphs SP, TH, and TX. The horizontal axis shows Wh.

In some embodiments, the temperature profile may include storage information. For example, the temperature profile can provide heating and/or cooling information for long term storage of one or more reagents contained within a diagnostic device or system described herein (e.g., to thermostabilize the one or more reagents). In some embodiments, for example, the temperature profile can configure the temperature control device to maintain a room temperature (e.g., 20° C. to 25° C.) for a relatively long period of time (e.g., at least 1 month, at least 3 months, at least 6 months, at least 9 months, at least 1 year, at least 5 years, at least 10 years). In some embodiments, the temperature profile can configure the temperature control device to maintain the diagnostic device or system for storage across a range of temperatures (e.g., 0° C. to 20° C., 0° C. to 37° C., 0° C. to 60° C., 0° C. to 90° C., 20° C. to 37° C., 20° C. to 60° C., 20° C. to 90° C., 37° C. to 60° C., 37° C. to 90° C., 60° C. to 90° C.) for a relatively long period of time (e.g., at least 1 month, at least 3 months, at least 6 months, at least 9 months, at least 1 year, at least 5 years, at least 10 years).

II. Exemplary Tests for Use with the Temperature Profile Encoding Techniques

The following sections describe aspects of exemplary diagnostic devices, tests and test steps that can be used with the temperature profile encoding techniques described herein, which are for illustrative purposes and are not intended to be limiting. Therefore, it should be appreciated that the temperature profile encoding techniques described herein are not limited to such aspects, and can be used with any test, diagnostic device, or test kit.

Diagnostic devices, systems, and methods described herein may be safely and easily operated or conducted by untrained individuals. Unlike prior art diagnostic tests, some embodiments described herein may not require knowledge of even basic laboratory techniques (e.g., pipetting). Similarly, some embodiments described herein may not require expensive laboratory equipment (e.g., thermocyclers). In some embodiments, reagents, buffers, diluents, or any other appropriate materials may be contained within fluid containers (e.g., depots, reservoirs, receptacles) of the device. In this way, the fluids and/or materials for the diagnostic test may be protected from contamination (either from surrounding gases/fluids or from cross-contamination within the device) until operation.

Diagnostic devices, systems, and methods described herein are also highly sensitive and accurate. In some embodiments, the diagnostic devices, systems, and methods are configured to detect one or more target nucleic acid sequences using nucleic acid amplification (e.g., an isothermal nucleic acid amplification method). Through nucleic acid amplification, the diagnostic devices, systems, and methods are able to accurately detect the presence of extremely small amounts of a target nucleic acid. In certain cases, for example, the diagnostic devices, systems, and methods can detect 1 pM or less, or 10 aM or less.

As a result, the diagnostic devices, systems, and methods described herein may be useful in a wide variety of contexts. For example, in some cases, the diagnostic devices and systems may be available over the counter for use by consumers. In such cases, untrained consumers may be able to self administer the diagnostic test (or administer the test to friends and family members) in their own homes (or any other location of their choosing). In some cases, the diagnostic devices, systems, or methods may be operated or performed by employees or volunteers of an organization (e.g., a school, a medical office, a business). For example, a school (e.g., an elementary school, a high school, a university) may test its students, teachers, and/or administrators, a medical office (e.g., a doctor's office, a dentist's office) may test its patients, or a business may test its employees for a particular disease. In each case, the diagnostic devices, systems, or methods may be operated or performed by the test subjects (e.g., students, teachers, patients, employees) or by designated individuals (e.g., a school nurse, a teacher, a school administrator, a receptionist).

In some embodiments, diagnostic devices described herein are relatively small. Thus, unlike diagnostic tests that require bulky equipment, diagnostic devices and systems described herein may be easily transported and/or easily stored in homes and businesses. In some embodiments, the diagnostic devices and systems may be relatively inexpensive. Since no expensive laboratory equipment (e.g., a thermocycler) is required, diagnostic devices, systems, and methods described herein may be more cost effective than known diagnostic tests.

In some embodiments, any reagents contained within a diagnostic device or system described herein may be thermostabilized, and the diagnostic device or system may be shelf stable for a relatively long period of time. In certain embodiments, for example, the housing including the one or more solutions may be stored at room temperature (e.g., 20° C. to 25° C.) for a relatively long period of time (e.g., at least 1 month, at least 3 months, at least 6 months, at least 9 months, at least 1 year, at least 5 years, at least 10 years). In certain embodiments, the diagnostic device may be stored across a range of temperatures (e.g., 0° C. to 20° C., 0° C. to 37° C., 0° C. to 60° C., 0° C. to 90° C., 20° C. to 37° C., 20° C. to 60° C., 20° C. to 90° C., 37° C. to 60° C., 37° C. to 90° C., 60° C. to 90° C.) for a relatively long period of time (e.g., at least 1 month, at least 3 months, at least 6 months, at least 9 months, at least 1 year, at least 5 years, at least 10 years).

A. Target Nucleic Acid Sequences

The diagnostic devices, systems, and methods described herein may be used to detect the presence or absence of any target nucleic acid sequence (e.g., from any pathogen of interest) or multiple target nucleic acid sequences. Target nucleic acid sequences may be associated with a variety of diseases or disorders. In some embodiments, the diagnostic devices, systems, and methods are used to diagnose at least one disease or disorder caused by a pathogen. In certain instances, the diagnostic devices, systems, and methods are configured to detect a nucleic acid encoding a protein (e.g., a nucleocapsid protein) of SARS-CoV-2, which is the virus that causes COVID-19. In some embodiments, the diagnostic devices, systems, and methods are used to diagnose at least one disease or disorder caused by a virus, bacteria, fungus, protozoan, parasite, and/or cancer cell. Of course, a diagnostic test according to exemplary embodiments described herein may be employed to detect any desired target nucleic acid sequence, as the present disclosure is not so limited.

B. Diagnostic Systems

According to some embodiments, diagnostic systems comprise a sample-collecting component (e.g., a swab) and a diagnostic device. In certain cases, the diagnostic device comprises a plurality of openable fluid containers. In some cases, the diagnostic device comprises a detection component (e.g., a lateral flow assay strip). In certain embodiments, the diagnostic device further comprises one or more reagents (e.g., lysis reagents, nucleic acid amplification reagents, CRISPR/Cas detection reagents). Each of the one or more reagents may be in liquid form (e.g., in solution) or in solid form (e.g., lyophilized, dried, crystallized, air jetted). The diagnostic device may also comprise an integrated heater, or the diagnostic system may comprise a separate heater configured to heat one or more fluid containers or other portion of a diagnostic system. In some embodiments, a heater may be a printed circuit board (PCB) heater that may be integrated into a diagnostic device.

C. Temperature Control Device

The diagnostic system, in some embodiments, comprises a temperature control device. In certain embodiments, the temperature control device is integrated with the diagnostic device. In some instances, for example, the temperature control device is a printed circuit board (PCB) heater. The PCB heater, in some embodiments, comprises a bonded PCB with a microcontroller, thermistors, and/or resistive heaters. In certain embodiments, the diagnostic device comprises a cartridge and/or a blister pack comprising one or more reservoirs (e.g., a lysis reservoir, a nucleic acid amplification reservoir). In some embodiments, the PCB heater is in thermal communication with at least one of the one or more reservoirs. In some embodiments, the PCB heater is located adjacent to (e.g., below) at least one of the one or more reservoirs, amplification reservoirs)

In some embodiments, the diagnostic system comprises a separate temperature control device (e.g., a heating and/or cooling device that is not integrated with other system components). In some cases, the temperature control device comprises a battery-powered heat source, a USB-powered heat source, a hot plate, a heating coil, and/or a hot water bath. In some cases, the temperature control device comprises a heat sink, a cooling element, cold water, fans, and/or any other suitable cooling mechanisms. In certain embodiments, the temperature control device is contained within a thermally-insulated housing to ensure user safety. In certain instances, the temperature control device is an off-the-shelf consumer-grade device. In some embodiments, the heat source is a thermocycler or other specialized laboratory equipment known in the art. In some embodiments, the temperature control device is configured to receive a reaction tube or other consumable of the diagnostic system.

In some embodiments, the temperature control device is configured to heat one or more components of a diagnostic system (e.g., fluidic contents of a reaction tube or a reservoir) at a desired temperature. The desired temperature can be, for example, a desired temperature of at least 37° C., at least 40° C., at least 45° C., at least 50° C., at least 55° C., at least 60° C., at least 65° C., at least 70° C., at least 75° C., at least 80° C., at least 85° C., or at least 90° C., etc. In some embodiments, the temperature control device is configured to heat one or more components of a diagnostic system (e.g., fluidic contents of a reaction tube or a reservoir) at a temperature in a desired temperature range. The desired temperature range can be, for example, a desired temperature range from 37° C. to 60° C., 37° C. to 70° C., 37° C. to 80° C., 37° C. to 90° C., 40° C. to 60° C., 40° C. to 70° C., 40° C. to 80° C., 40° C. to 90° C., 50° C. to 60° C., 50° C. to 70° C., 50° C. to 80° C., 50° C. to 90° C., 60° C. to 70° C., 60° C. to 80° C., 60° C. to 90° C., 70° C. to 80° C., 70° C. to 90° C., or 80° C. to 90° C., etc.

In some embodiments, the temperature control device is configured to cool one or more components of a diagnostic system (e.g., fluidic contents of a reaction tube or a reservoir) to a desired temperature. The desired temperature can be, for example, a temperature of at most 0° C., at most 5° C., at most 10° C., at most 15° C., at most 20° C., at most 25° C., at most 30° C., at most 37° C., at most 40° C., at most 45° C., at most 50° C., at most 55° C., at most 60° C., at most 65° C., at most 70° C., at most 75° C., at most 80° C., at most 85° C., or at most 90° C., etc. In some embodiments, the temperature control device is configured to cool one or more components of a diagnostic system (e.g., fluidic contents of a reaction tube or a reservoir) at a temperature in a desired temperature range. The desired temperature range can, for example, be from 60° C. to 0° C., 70° C. to 0° C., 80° C. to 0° C., 90° C. to 0° C., 60° C. to 37° C., 70° C. to 37° C., 80° C. to 37° C., 90° C. to 37° C., 60° C. to 40° C., 70° C. to 40° C., 80° C. to 40° C., 90° C. to 40° C., 60° C. to 50° C., 70° C. to 50° C., 80° C. to 50° C., 90° C. to 50° C., 70° C. to 60° C., 80° C. to 60° C., 90° C. to 60° C., 80° C. to 70° C., 90° C. to 70° C., or 90° C. to 80° C., etc.

In some embodiments, the temperature control device is configured to heat and/or cool one or more components of a diagnostic system (e.g., fluidic contents of a reaction tube or a reservoir) at a temperature for a desired amount of time. The desired amount of time can be, for example, at least 5 minutes, at least 10 minutes, at least 15 minutes, at least 30 minutes, at least 45 minutes, at least 60 minutes, or at least 90 minutes, etc. In certain embodiments, the temperature control device is configured to heat and/or cool one or more components of a diagnostic system (e.g., fluidic contents of a reaction tube or a reservoir) at a desired temperature for a time in a desired range. The range can be, for example, from 5 minutes to 10 minutes, 5 minutes to 15 minutes, 5 minutes to 30 minutes, 5 minutes to 45 minutes, 5 minutes to 60 minutes, 5 minutes to 90 minutes, 10 minutes to 15 minutes, 10 minutes to 30 minutes, 10 minutes to 45 minutes, 10 minutes to 60 minutes, 10 minutes to 90 minutes, 15 minutes to 30 minutes, 15 minutes to 45 minutes, 15 minutes to 60 minutes, 15 minutes to 90 minutes, 30 minutes to 45 minutes, 30 minutes to 60 minutes, 30 minutes to 90 minutes, or 60 minutes to 90 minutes, etc.

In some embodiments, the temperature control device comprises at least two temperature zones. In certain instances, for example, the temperature control device is an off-the-shelf consumer-grade heating coil connected to a microcontroller that is used to switch between two temperature zones. In some embodiments, the first temperature zone is in a first temperature range. The first temperature range can be, for example, from 60° C. to 100° C., 60° C. to 90° C., 60° C. to 80° C., 60° C. to 70° C., or 60° C. to 65° C., etc. In certain cases, the first temperature zone has a temperature of approximately 65° C. In some embodiments, the second temperature zone is in a second temperature range. The second temperature range can be, for example, from 30° C. to 40° C. In certain cases, the second temperature zone has a temperature of approximately 37° C.

It should be appreciated that while exemplary temperatures, temperature ranges, times, and time ranges are provided herein, they are intended for illustrative purposes only and are not intended to limit the techniques described herein. For example, the temperature and temperature ranges can be approximate temperatures (e.g., within one degree, within two degrees, within three degrees, and so on). As another example, the times and time ranges can be approximate times (e.g., within ten seconds, thirty seconds, one minute, ninety seconds, two minutes, and so on).

In some embodiments, the temperature control device is configured to heat and/or cool one or more components of a diagnostic system (e.g., fluidic contents of a reaction tube or a reservoir) to a plurality of temperatures for a plurality of time periods. In some embodiments, for example, a temperature control device is configured to heat and/or cool one or more components of a diagnostic system (e.g., fluidic contents of a reaction tube or a reservoir) at a first temperature for a first period of time and at a second temperature for a second period of time. The first temperature and the second temperature may be the same or different, and the first period of time and the second period of time may be the same or different.

In some embodiments, the temperature control device is pre-programmed with one or more temperature profiles. In some embodiments, for example, the temperature control device is pre-programmed with a lysis heating protocol and/or an amplification heating protocol. A lysis heating protocol generally refers to a set of one or more temperatures and one or more time periods that facilitate lysis of the sample. An amplification heating protocol generally refers to a set of one or more temperatures and one or more time periods that facilitate nucleic acid amplification. As described herein, in some embodiments, the temperature control device comprises an auto-start mechanism that corresponds to the temperature profile needed for lysis and/or amplification. That is, a user may insert a reaction tube into the temperature control device, and the temperature control device may automatically run a temperature profile corresponding to a lysis and/or amplification heating protocol. In some embodiments, the temperature control device may be controlled by a mobile application.

D. “Chimney” Detection Component

In some embodiments, a diagnostic device comprises a detection component comprising a “chimney” configured to receive a reaction tube. One embodiment of a “chimney” detection component is shown in FIG. 4. In FIG. 4, detection component 100 comprises chimney 110, front panel 120 comprising opening 130, and back panel 140 comprising puncturing component 150 and lateral flow assay strip 160.

In operation, a reaction tube comprising fluidic contents may be inserted into chimney 110. In some embodiments, the reaction tube may be punctured by puncturing component 130. As a result, at least a portion of the fluidic contents of the reaction tube may be deposited on a first sub-region (e.g., a sample pad) of lateral flow assay strip 160 (e.g., via capillary action).

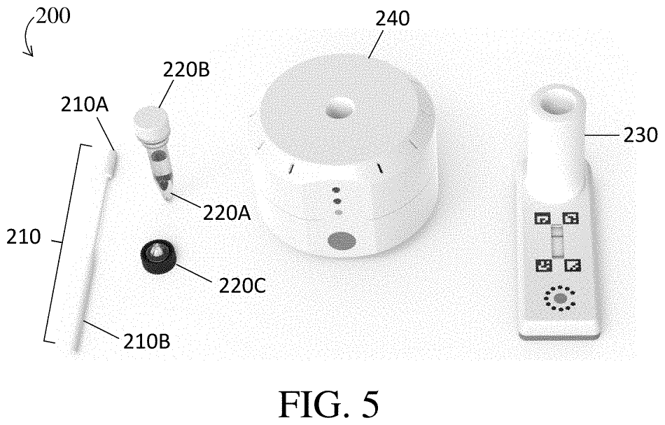

One embodiment of a diagnostic system comprising a “chimney” detection component is shown in FIG. 5. In FIG. 5, diagnostic system 200 comprises sample-collecting component 210, reaction tube 220, “chimney” detection component 230, and temperature control device 240. As shown in FIG. 5, sample-collecting component 210 may be a swab comprising swab element 210A and stem element 210B. In certain embodiment, reaction tube 220 comprises tube 220A, first cap 220B, and second cap 220C, which can include one or more reagents (e.g., lysis reagents, nucleic acid amplification reagents, CRISPR/Cas detection reagents) and/or a reaction buffer.

In operation, a user may collect a sample that is inserted into the fluidic contents of tube 220A similar as described above. In some embodiments, reaction tube 220 may be inserted into temperature control device 240. Reaction tube 220 may be heated and/or cooled at one or more temperatures (e.g., at least 37° C., at least 65° C.) and/or cooled at one or more temperatures (e.g., at most 20° C., at most 37° C.) for one or more periods of time. In some cases, heating and/or cooling reaction tube 220 according to a first temperature profile (e.g., a first set of temperature(s) and time period(s)) may facilitate lysis of cells within the collected sample. In a particular, non-limiting embodiment, a first temperature profile comprises heating and/or cooling reaction tube 220 at 37° C. for 5-10 minutes (e.g., about 3 minutes) and at 65° C. for 5-10 minutes (e.g., about 10 minutes). In some cases, heating and/or cooling reaction tube 220 according to a second temperature profile (e.g., a second set of temperature(s) and time period(s)) may facilitate amplification of one or more target nucleic acids (if present within the sample). In a particular, non-limiting embodiment, a second temperature profile comprises heating and/or cooling reaction tube 220 at 37° C. for 10-15 minutes. In some cases, the temperature control device may comprise an indicator (e.g., a visual indicator) that a temperature profile is occurring. The indicator may indicate to a user when the reaction tube should be removed from the device.

Following heating and/or cooling, reaction tube 220 may be inserted into “chimney” detection component 230. Upon insertion, reaction tube 220 may be punctured by a puncturing component (e.g., a blade, a needle) of “chimney” detection component 230 so that the fluidic contents of reaction tube 220 may flow through the lateral flow assay strip (e.g., via capillary action), and the presence or absence of one or more target nucleic acid sequences may be indicated on a portion of the lateral flow assay strip (e.g., by the formation of one or more lines on the lateral flow assay strip).

In some embodiments, multiple temperature profiles can be performed (e.g., using different reagents). For example, the sample and one or more reagents can be added to the reaction tube 220, which may be heated and/or cooled in temperature control device 240 according to a first temperature profile. In certain embodiments, for example, heating and/or cooling reaction tube 220 according to the first temperature profile may facilitate lysis of cells within the collected sample. In a particular, non-limiting embodiment, a first temperature profile comprises heating and/or cooling reaction tube 220 at 37° C. for 5-10 minutes (e.g., about 3 minutes) and at 65° C. for 5-10 minutes (e.g., about 10 minutes). After completion of the first temperature profile, one or more reagents (e.g., nucleic acid amplification reagents) can be added to tube 220A, and reaction tube 220 may be heated and/or cooled in temperature control device 240 according to a second temperature profile. In certain embodiments, for example, heating and/or cooling reaction tube 220 according to the second temperature profile may facilitate amplification of one or more target nucleic acid sequences (if present in the sample). In a particular, non-limiting embodiment, a second temperature profile comprises heating and/or cooling reaction tube 220 at 32° C. for 1-10 minutes (e.g., about 3 minutes), at 65° C. for 10-40 minutes, and at 37° C. for 10-20 minutes (e.g., about 15 minutes).

E. Cartridges

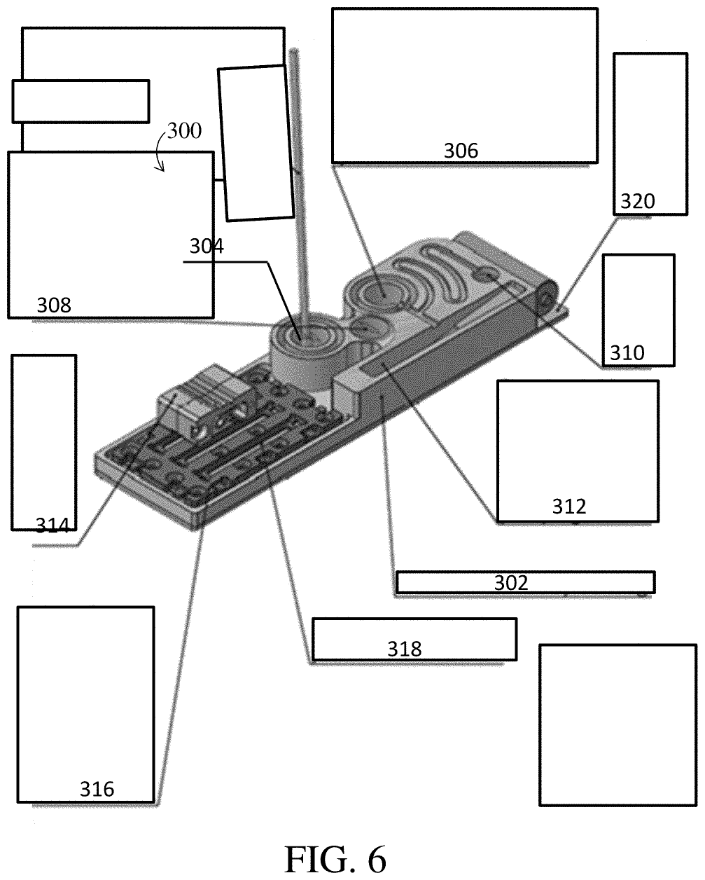

In some embodiments, a diagnostic device comprises a cartridge (e.g., a microfluidic cartridge). An exemplary cartridge is shown in FIG. 6, which includes a cartridge body 302 that comprises first reagent reservoir 304, second reagent reservoir 306, third reagent reservoir 308, vent path 310, and detection region 312. In some embodiments, detection region 312 comprises a lateral flow assay strip configured to detect one or more target nucleic acid sequences. In certain embodiments, the lateral flow assay strip comprises one or more test lines comprising one or more capture reagents (e.g., immobilized antibodies) configured to detect one or more target nucleic acid sequences.

In some embodiments, cartridge 300 comprises an integrated heater 320. In some embodiments, heater 320 is a PCB heater. The PCB heater, in some embodiments, comprises a bonded PCB with a microcontroller, thermistors, and resistive heaters. In some embodiments, the heater comprises a USB- and/or battery-powered heater. In some embodiments, one or more heating elements of heater 320 may be in thermal communication with first reagent reservoir 304 and/or second reagent reservoir 306. In certain instances, for example, one or more heating elements of heater 320 are located under first reagent reservoir 304 and/or second reagent reservoir 306. In some cases, heater 320 runs a first heating protocol (e.g., a lysis heating protocol) and/or a second heating protocol (e.g., a nucleic acid amplification protocol). In some instances, heater 320 is pre-programmed to run the first heating protocol and/or the second heating protocol.

In operation, a user may use a swab to collect a sample from a subject (e.g., the user, a friend or family member of the user, or any other human or animal subject) and then expose the contents of first reagent reservoir 304. In some embodiments, chemical lysis may be performed by one or more lysis reagents (e.g., enzymes, detergents) in first reagent reservoir 304. In certain embodiments, thermal lysis may be performed by heater 320. In certain cases, for example, heater 320 may heat first reagent reservoir 304 according to a first heating protocol (e.g., a lysis heating protocol). In this manner, one or more cells within the sample may be lysed.

In some embodiments, the user may push pumping tool 314 along one or more pump lanes to transport at least a portion of the fluidic contents of first reagent reservoir 304 (e.g., comprising a lysate) to second reagent reservoir 306. In some instances, second reagent reservoir 306 comprises a second set of reagents (e.g., one or more nucleic acid amplification reagents). In certain cases, heater 320 may heat second reagent reservoir 306 according to a second heating protocol (e.g., a nucleic acid amplification heating protocol). In this manner, one or more target nucleic acid sequences may be amplified (if present within the sample).

In some embodiments, the fluidic contents of second reagent reservoir 306 (e.g., amplicon-containing fluid) may be transported to detection region 312 by pushing pumping tool 314 along one or more pump lanes. In this manner, at least a portion of the fluidic contents of second reagent reservoir 306 may be introduced into a first portion (e.g., sample pad) of a lateral flow assay strip in detection region 312. The user may be able to determine whether or not one or more target nucleic acid sequences are present based on the formation (or lack thereof) of one or more opaque lines (or other markings) on the lateral flow assay strip.

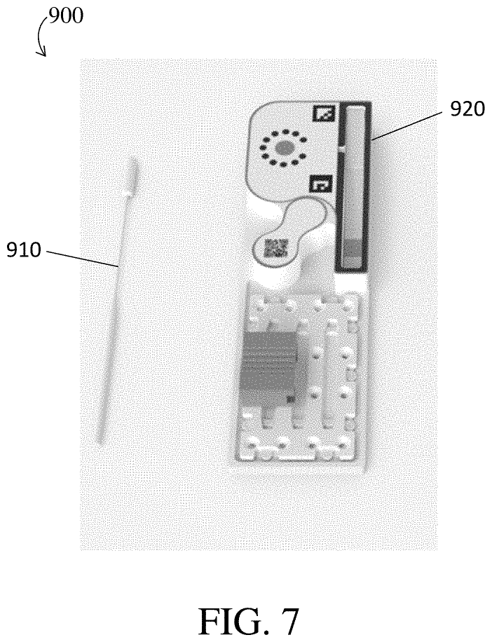

In some cases, a cartridge may be a component of a diagnostic system. For example, FIG. 7 illustrates an exemplary diagnostic system 900 comprising sample-collecting swab 910 and cartridge 920. In some embodiments, the diagnostic system may be used with an electronic device (e.g., a smartphone, a tablet) and associated software (e.g., a mobile application). In certain embodiments, for example, the software may provide instructions for using the cartridge, may read and/or analyze results, and/or report results. In certain instances, the electronic device may communicate with the cartridge (e.g., via a wireless connection).

F. Blister Pack Embodiments

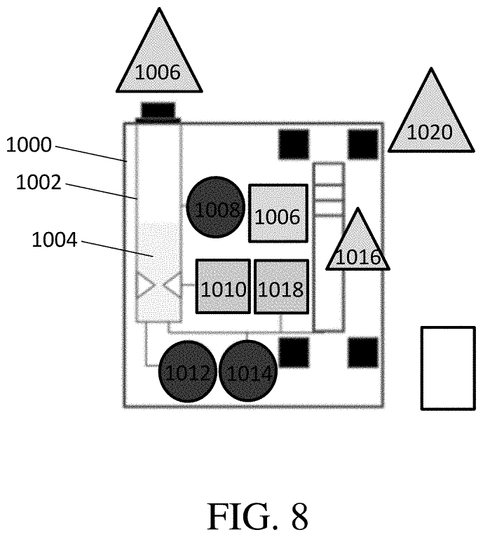

In some embodiments, a diagnostic device comprises one or more blister packs. One embodiment is shown in FIG. 8. In FIG. 8, diagnostic device 1000 comprises tube 1002 containing reaction buffer 1004. In certain embodiments, diagnostic device 1000 comprises a temperature control device in thermal communication with tube 1002.

In operation, a sample may be added through sample port 1006. A first blister pack 1008 comprising one or more lysis and/or decontamination reagents (e.g., UDG) are released from blister pack 1008 into tube 1002. In some embodiments, tube 1002 may be heated and/or cooled by a temperature control device (not shown in FIG. 8). In some cases, mechanism 1010 provides a physical mechanism to reduce sample volume as needed. In certain embodiments, one or more amplification reagents are released from amplification blister pack 1012 into tube 1002. In some instances, a dilution buffer may optionally be released from dilution blister pack 1014 into tube 1002. The sample is then flowed across a lateral flow assay strip 1016, with mechanism 1018 ensuring that the sample accesses lateral flow assay strip 1016 at the appropriate time (e.g., after the processing is complete).

A further embodiment of the blister pack configuration comprises a swab in conjunction with a blister pack. A sample is taken using a swab. The swab is added to a tube comprising buffer and incubated for 10 minutes at room temperature. Then, a cap comprising one or more lysis reagents is added to the tube. Adding the cap dispenses the lysis reagents into the buffer and sample. The mixture is then heated at 95° C. for three minutes but the invention is not so limited. Other temperatures are envisioned. In some embodiments, the heating is accomplished with any heater described herein (e.g., a temperature control device, boiling water, a fixed heat source, etc.). The reaction mixture is then allowed to cool for 1 minute, but this time period is not limiting as other time periods are envisioned. The resulting reaction mixture is then injected into a sample port of the blister pack (e.g., using a pipette). The cartridge is then sealed with seal tape and then shaken or otherwise agitated for 10 seconds but this time period is not limiting. The cartridge is heated for 20 minutes but this time period also is not limiting. In some embodiments, the cartridge is heated using a temperature control device and/or placed in a user's clothing pocket (e.g., back pocket of pants, front pocket of pants, front pocket of shirt) to heat the cartridge using the user's body heat. The user then pushes on a first blister to release a one or more amplification reagents (e.g., one or more reagents for LAMP, RPA, NEAR, or other isothermal amplification methods). The user presses on a second blister to release the dilution buffer and turns a valve to permit the mixture to proceed to a lateral flow strip after the appropriate amount of processing. The lateral flow strip may indicate whether one or more target nucleic acid sequences are present in the sample.

G. Sample Collection

In some embodiments, a diagnostic method comprises collecting a sample from a subject (e.g., a human subject, an animal subject). In some embodiments, a diagnostic system comprises a sample-collecting component configured to collect a sample from a subject (e.g., a human subject, an animal subject). Exemplary samples include bodily fluids (e.g., mucus, saliva, blood, serum, plasma, amniotic fluid, sputum, urine, cerebrospinal fluid, lymph, tear fluid, feces, or gastric fluid), cell scrapings (e.g., a scraping from the mouth or interior cheek), exhaled breath particles, tissue extracts, culture media (e.g., a liquid in which a cell, such as a pathogen cell, has been grown), environmental samples, agricultural products or other foodstuffs, and their extracts. In some embodiments, the sample comprises a nasal secretion. In certain instances, for example, the sample is an anterior nares specimen. An anterior nares specimen may be collected from a subject by inserting a swab element of a sample-collecting component into one or both nostrils of the subject for a period of time. In some embodiments, the sample comprises a cell scraping. In certain embodiments, the cell scraping is collected from the mouth or interior cheek. The cell scraping may be collected using a brush or scraping device formulated for this purpose. The sample may be self-collected by the subject or may be collected by another individual (e.g., a family member, a friend, a coworker, a health care professional) using a sample-collecting component described herein.

Lysis of Sample

In some embodiments, lysis is performed by chemical lysis (e.g., exposing a sample to one or more lysis reagents) and/or thermal lysis (e.g., heating a sample). Chemical lysis may be performed by one or more lysis reagents. In some embodiments, the one or more lysis reagents comprise one or more enzymes. In some embodiments, the one or more lysis reagents comprise one or more detergents.

In some embodiments, the lysis pellet or tablet is thermostabilized and is stable across a wide range of temperatures. In some embodiments, the lysis pellet or tablet is stable at a temperature of at least 0° C., at least 10° C., at least 20° C., at least 37° C., at least 40° C., at least 50° C., at least 60° C., at least 65° C., at least 70° C., at least 80° C., at least 90° C., or at least 100° C. In some embodiments, the lysis pellet or tablet is stable at a temperature in a range from 0° C. to 10° C., 0° C. to 20° C., 0° C. to 37° C., 0° C. to 40° C., 0° C. to 50° C., 0° C. to 60° C., 0° C. to 65° C., 0° C. to 70° C., 0° C. to 80° C., 0° C. to 90° C., 0° C. to 100° C., 10° C. to 20° C., 10° C. to 37° C., 10° C. to 40° C., 10° C. to 50° C., 10° C. to 60° C., 10° C. to 65° C., 10° C. to 70° C., 10° C. to 80° C., 10° C. to 90° C., 10° C. to 100° C., 20° C. to 37° C., 20° C. to 40° C., 20° C. to 50° C., 20° C. to 60° C., 20° C. to 65° C., 20° C. to 70° C., 20° C. to 80° C., 20° C. to 90° C., 20° C. to 100° C., 30° C. to 37° C., 30° C. to 50° C., 30° C. to 60° C., 30° C. to 65° C., 30° C. to 70° C., 30° C. to 80° C., 30° C. to 90° C., 37° C. to 50° C., 37° C. to 60° C., 37° C. to 65° C., 37° C. to 70° C., 37° C. to 80° C., 37° C. to 90° C., 50° C. to 60° C., 50° C. to 65° C., 50° C. to 70° C., 50° C. to 80° C., 50° C. to 90° C., 60° C. to 65° C., 60° C. to 70° C., 60° C. to 80° C., 60° C. to 90° C., 65° C. to 80° C., 65° C. to 90° C., 70° C. to 80° C., or 70° C. to 90° C.

In some embodiments, the one or more lysis reagents are active at approximately room temperature (e.g., 20° C.-25° C.). In some embodiments, the one or more lysis reagents are active at elevated temperatures (e.g., at least 37° C., at least 40° C., at least 50° C., at least 60° C., at least 65° C., at least 70° C., at least 80° C., at least 90° C.). In some embodiments, chemical lysis is performed at a temperature in a range from 20° C. to 25° C., 20° C. to 30° C., 20° C. to 37° C., 20° C. to 50° C., 20° C. to 60° C., 20° C. to 65° C., 20° C. to 70° C., 20° C. to 80° C., 20° C. to 90° C., 25° C. to 30° C., 25° C. to 37° C., 25° C. to 50° C., 25° C. to 60° C., 25° C. to 65° C., 25° C. to 70° C., 25° C. to 80° C., 25° C. to 90° C., 30° C. to 37° C., 30° C. to 50° C., 30° C. to 60° C., 30° C. to 65° C., 30° C. to 70° C., 30° C. to 80° C., 30° C. to 90° C., 37° C. to 50° C., 37° C. to 60° C., 37° C. to 65° C., 37° C. to 70° C., 37° C. to 80° C., 37° C. to 90° C., 50° C. to 60° C., 50° C. to 65° C., 50° C. to 70° C., 50° C. to 80° C., 50° C. to 90° C., 60° C. to 65° C., 60° C. to 70° C., 60° C. to 80° C., 60° C. to 90° C., 65° C. to 80° C., 65° C. to 90° C., 70° C. to 80° C., or 70° C. to 90° C.

In some embodiments, cell lysis is accomplished by applying heat to a sample (thermal lysis). In certain instances, thermal lysis is performed by applying a lysis heating protocol comprising heating the sample at one or more temperatures for one or more time periods using any heater described herein. In some embodiments, a lysis heating protocol comprises heating the sample at a first temperature for a first time period. In certain instances, the first temperature is at least 37° C., at least 50° C., at least 60° C., at least 65° C., at least 70° C., at least 80° C., or at least 90° C. In certain instances, the first temperature is in a range from 37° C. to 50° C., 37° C. to 60° C., 37° C. to 65° C., 37° C. to 70° C., 37° C. to 80° C., 37° C. to 90° C., 50° C. to 60° C., 50° C. to 65° C., 50° C. to 70° C., 50° C. to 80° C., 50° C. to 90° C., 60° C. to 65° C., 60° C. to 70° C., 60° C. to 80° C., 60° C. to 90° C., 65° C. to 80° C., 65° C. to 90° C., 70° C. to 80° C., or 70° C. to 90° C. In certain instances, the first time period is at least 1 minute, at least 2 minutes, at least 3 minutes, at least 4 minutes, at least 5 minutes, at least 10 minutes, at least 15 minutes, at least 20 minutes, or at least 30 minutes. In certain instances, the first time period is in a range from 1 to 3 minutes, 1 to 5 minutes, 1 to 10 minutes, 1 to 15 minutes, 1 to 20 minutes, 1 to 30 minutes, 3 to 5 minutes, 3 to 10 minutes, 3 to 15 minutes, 3 to 20 minutes, 3 to 30 minutes, 5 to 10 minutes, 5 to 15 minutes, 5 to 20 minutes, 5 to 30 minutes, 10 to 20 minutes, 10 to 30 minutes, or 20 to 30 minutes. In some embodiments, a lysis heating protocol comprises heating the sample at a second temperature for a second time period. In certain instances, the second temperature is at least 37° C., at least 50° C., at least 60° C., at least 65° C., at least 70° C., at least 80° C., or at least 90° C. In certain instances, the second temperature is in a range from 37° C. to 50° C., 37° C. to 60° C., 37° C. to 65° C., 37° C. to 70° C., 37° C. to 80° C., 37° C. to 90° C., 50° C. to 60° C., 50° C. to 65° C., 50° C. to 70° C., 50° C. to 80° C., 50° C. to 90° C., 60° C. to 65° C., 60° C. to 70° C., 60° C. to 80° C., 60° C. to 90° C., 65° C. to 80° C., 65° C. to 90° C., 70° C. to 80° C., or 70° C. to 90° C. In certain instances, the second time period is at least 1 minute, at least 2 minutes, at least 3 minutes, at least 4 minutes, at least 5 minutes, at least 10 minutes, at least 15 minutes, at least 20 minutes, or at least 30 minutes. In certain instances, the second time period is in a range from 1 to 3 minutes, 1 to 5 minutes, 1 to 10 minutes, 1 to 15 minutes, 1 to 20 minutes, 1 to 30 minutes, 3 to 5 minutes, 3 to 10 minutes, 3 to 15 minutes, 3 to 20 minutes, 3 to 30 minutes, 5 to 10 minutes, 5 to 15 minutes, 5 to 20 minutes, 5 to 30 minutes, 10 to 20 minutes, 10 to 30 minutes, or 20 to 30 minutes. In a particular, non-limiting embodiment, the first temperature is in a range from 37° C. to 50° C. (e.g., about 37° C.) and the first time period is in a range from 1 minute to 5 minutes (e.g., about 3 minutes), and the second temperature is in a range from 60° C. to 70° C. (e.g., about 65° C.) and the second time period is in a range from 5 minutes to 15 minutes (e.g., about 10 minutes). In some embodiments, a lysis heating protocol may comprise heating a sample at one or more additional temperatures for one or more additional time periods.

I. Nucleic Acid Amplification

Following lysis, one or more target nucleic acids (e.g., a nucleic acid of a target pathogen) may be amplified. In some cases, a target pathogen has RNA as its genetic material. In certain instances, for example, a target pathogen is an RNA virus (e.g., a coronavirus, an influenza virus). In some such cases, the target pathogen's RNA may need to be reverse transcribed to DNA prior to amplification. As described herein, the nucleic acid amplification reagents can be loop-mediated isothermal amplification (LAMP), recombinase polymerase amplification (RPA), nicking enzyme amplification reaction (NEAR), and/or the like. In some embodiments, the amplification pellet or tablet is thermostabilized and is stable across a wide range of temperatures. In some embodiments, the amplification pellet or tablet is stable at a temperature of at least 0° C., at least 10° C., at least 20° C., at least 37° C., at least 40° C., at least 50° C., at least 60° C., at least 65° C., at least 70° C., at least 80° C., at least 90° C., or at least 100° C. In some embodiments, the amplification pellet or tablet is stable at a temperature in a range from 0° C. to 10° C., 0° C. to 20° C., 0° C. to 37° C., 0° C. to 40° C., 0° C. to 50° C., 0° C. to 60° C., 0° C. to 65° C., 0° C. to 70° C., 0° C. to 80° C., 0° C. to 90° C., 0° C. to 100° C., 10° C. to 20° C., 10° C. to 37° C., 10° C. to 40° C., 10° C. to 50° C., 10° C. to 60° C., 10° C. to 65° C., 10° C. to 70° C., 10° C. to 80° C., 10° C. to 90° C., 10° C. to 100° C., 20° C. to 37° C., 20° C. to 40° C., 20° C. to 50° C., 20° C. to 60° C., 20° C. to 65° C., 20° C. to 70° C., 20° C. to 80° C., 20° C. to 90° C., 20° C. to 100° C., 30° C. to 37° C., 30° C. to 50° C., 30° C. to 60° C., 30° C. to 65° C., 30° C. to 70° C., 30° C. to 80° C., 30° C. to 90° C., 37° C. to 50° C., 37° C. to 60° C., 37° C. to 65° C., 37° C. to 70° C., 37° C. to 80° C., 37° C. to 90° C., 50° C. to 60° C., 50° C. to 65° C., 50° C. to 70° C., 50° C. to 80° C., 50° C. to 90° C., 60° C. to 65° C., 60° C. to 70° C., 60° C. to 80° C., 60° C. to 90° C., 65° C. to 80° C., 65° C. to 90° C., 70° C. to 80° C., or 70° C. to 90° C.

In some embodiments, an isothermal amplification method described herein comprises applying heat to a sample. In certain instances, an amplification method comprises applying an amplification heating protocol comprising heating the sample at one or more temperatures for one or more time periods using any heater described herein. In some embodiments, an amplification heating protocol comprises heating the sample at a first temperature (e.g., at least 30° C., at least 65° C., etc.) for a first time period (e.g., at least 1 minute, at least 20 minutes, a range from 1 to 3 minutes, 1 to 5 minutes, etc). In certain instances, the first temperature is at least 30° C., at least 32° C., at least 37° C., at least 50° C., at least 60° C., at least 65° C., at least 70° C., at least 80° C., or at least 90° C. In certain instances, the first temperature is in a temperature range. The temperature range can be, for example, from 30° C. to 37° C., 30° C. to 50° C., 30° C. to 60° C., 30° C. to 65° C., 30° C. to 70° C., 30° C. to 80° C., 30° C. to 90° C., 37° C. to 50° C., 37° C. to 60° C., 37° C. to 65° C., 37° C. to 70° C., 37° C. to 80° C., 37° C. to 90° C., 50° C. to 60° C., 50° C. to 65° C., 50° C. to 70° C., 50° C. to 80° C., 50° C. to 90° C., 60° C. to 65° C., 60° C. to 70° C., 60° C. to 80° C., 60° C. to 90° C., 65° C. to 80° C., 65° C. to 90° C., 70° C. to 80° C., or 70° C. to 90° C., etc. In certain instances, the first time period is at least 1 minute, at least 2 minutes, at least 3 minutes, at least 4 minutes, at least 5 minutes, at least 10 minutes, at least 15 minutes, at least 20 minutes, or at least 30 minutes. In certain instances, the first time period is in a range from 1 to 3 minutes, 1 to 5 minutes, 1 to 10 minutes, 1 to 15 minutes, 1 to 20 minutes, 1 to 30 minutes, 3 to 5 minutes, 3 to 10 minutes, 3 to 15 minutes, 3 to 20 minutes, 3 to 30 minutes, 5 to 10 minutes, 5 to 15 minutes, 5 to 20 minutes, 5 to 30 minutes, 10 to 20 minutes, 10 to 30 minutes, or 20 to 30 minutes, etc.

In some embodiments, an amplification heating protocol comprises heating the sample at a second temperature for a second time period. In certain instances, the second temperature is at least 30° C., at least 32° C., at least 37° C., at least 50° C., at least 60° C., at least 65° C., at least 70° C., at least 80° C., or at least 90° C., etc. In certain instances, the second temperature is in a range from 30° C. to 37° C., 30° C. to 50° C., 30° C. to 60° C., 30° C. to 65° C., 30° C. to 70° C., 30° C. to 80° C., 30° C. to 90° C., 37° C. to 50° C., 37° C. to 60° C., 37° C. to 65° C., 37° C. to 70° C., 37° C. to 80° C., 37° C. to 90° C., 50° C. to 60° C., 50° C. to 65° C., 50° C. to 70° C., 50° C. to 80° C., 50° C. to 90° C., 60° C. to 65° C., 60° C. to 70° C., 60° C. to 80° C., 60° C. to 90° C., 65° C. to 80° C., 65° C. to 90° C., 70° C. to 80° C., or 70° C. to 90° C., etc. In certain instances, the second time period is at least 1 minute, at least 2 minutes, at least 3 minutes, at least 4 minutes, at least 5 minutes, at least 10 minutes, at least 15 minutes, at least 20 minutes, at least 30 minutes, at least 45 minutes, or at least 60 minutes, etc. In certain instances, the second time period is in a range from 1 to 3 minutes, 1 to 5 minutes, 1 to 10 minutes, 1 to 15 minutes, 1 to 20 minutes, 1 to 30 minutes, 1 to 45 minutes, 1 to 60 minutes, 3 to 5 minutes, 3 to 10 minutes, 3 to 15 minutes, 3 to 20 minutes, 3 to 30 minutes, 3 to 45 minutes, 3 to 60 minutes, 5 to 10 minutes, 5 to 15 minutes, 5 to 20 minutes, 5 to 30 minutes, 5 to 45 minutes, 5 to 60 minutes, 10 to 20 minutes, 10 to 30 minutes, 10 to 45 minutes, 10 to 60 minutes, 20 to 30 minutes, 20 to 45 minutes, 20 to 60 minutes, 30 to 45 minutes, 30 to 60 minutes, or 45 to 60 minutes, etc.

In some embodiments, an amplification heating protocol comprises heating the sample at a third temperature for a third time period. In certain instances, the third temperature is at least 30° C., at least 32° C., at least 37° C., at least 50° C., at least 60° C., at least 65° C., at least 70° C., at least 80° C., or at least 90° C., etc. In certain instances, the third temperature is in a range from 30° C. to 37° C., 30° C. to 50° C., 30° C. to 60° C., 30° C. to 65° C., 30° C. to 70° C., 30° C. to 80° C., 30° C. to 90° C., 37° C. to 50° C., 37° C. to 60° C., 37° C. to 65° C., 37° C. to 70° C., 37° C. to 80° C., 37° C. to 90° C., 50° C. to 60° C., 50° C. to 65° C., 50° C. to 70° C., 50° C. to 80° C., 50° C. to 90° C., 60° C. to 65° C., 60° C. to 70° C., 60° C. to 80° C., 60° C. to 90° C., 65° C. to 80° C., 65° C. to 90° C., 70° C. to 80° C., or 70° C. to 90° C., etc. In certain instances, the third time period is at least 1 minute, at least 2 minutes, at least 3 minutes, at least 4 minutes, at least 5 minutes, at least 10 minutes, at least 15 minutes, at least 20 minutes, at least 30 minutes, at least 45 minutes, or at least 60 minutes, etc. In certain instances, the third time period is in a range from 1 to 3 minutes, 1 to 5 minutes, 1 to 10 minutes, 1 to 15 minutes, 1 to 20 minutes, 1 to 30 minutes, 1 to 45 minutes, 1 to 60 minutes, 3 to 5 minutes, 3 to 10 minutes, 3 to 15 minutes, 3 to 20 minutes, 3 to 30 minutes, 3 to 45 minutes, 3 to 60 minutes, 5 to 10 minutes, 5 to 15 minutes, 5 to 20 minutes, 5 to 30 minutes, 5 to 45 minutes, 5 to 60 minutes, 10 to 20 minutes, 10 to 30 minutes, 10 to 45 minutes, 10 to 60 minutes, 20 to 30 minutes, 20 to 45 minutes, 20 to 60 minutes, 30 to 45 minutes, 30 to 60 minutes, or 45 to 60 minutes, etc.

In some embodiments, a lysis heating protocol may comprise heating a sample at one or more additional temperatures for one or more additional time periods.

1. LAMP

In some embodiments, the nucleic acid amplification reagents are LAMP reagents. LAMP refers to a method of amplifying a target nucleic acid using at least four primers through the creation of a series of stem-loop structures. Due to its use of multiple primers, LAMP may be highly specific for a target nucleic acid sequence.

2. RPA

In some embodiments, the nucleic acid amplification reagents are RPA reagents. RPA generally refers to a method of amplifying a target nucleic acid using a recombinase, a single-stranded DNA binding protein, and a strand-displacing polymerase.

3. Nicking Enzyme Amplification Reaction (NEAR)

In some embodiments, amplification of one or more target nucleic acids is accomplished through the use of a nicking enzyme amplification reaction (NEAR) reaction. NEAR generally refers to a method for amplifying a target nucleic acid using a nicking endonuclease and a strand displacing DNA polymerase. In some cases, NEAR may allow for amplification of very small amplicons.

J. Molecular Switches

As described herein, a sample undergoes lysis and amplification prior to detection. In certain embodiments, one or more (and, in some cases, all) of the reagents necessary for lysis and/or amplification are present in a single pellet or tablet. In some embodiments, a pellet or tablet may comprise two or more enzymes, and it may be necessary for the enzymes to be activated in a particular order. Therefore, in some embodiments, the enzyme tablet further comprises one or more molecular switches. Molecular switches, as described herein, are molecules that, in response to certain conditions, reversibly switch between two or more stable states. In some embodiments, the condition that causes the molecular switch to change its configuration is pH, light, temperature, an electric current, microenvironment, or the presence of ions and other ligands. In one embodiment, the condition is heat. In some embodiments, the molecular switches described herein are aptamers. Aptamers generally refer to oligonucleotides or peptides that bind to specific target molecules (e.g., the enzymes described herein). The aptamers, upon exposure to heat or other conditions, may dissociate from the enzymes. With the use of molecular switches, the processes described herein (e.g., lysis, decontamination, reverse transcription, and amplification) may be performed in a single test tube with a single enzymatic tablet.

K. Detection

In some embodiments, amplified nucleic acids (i.e., amplicons) may be detected using any suitable methods. In some embodiments, one or more target nucleic acid sequences are detected using a lateral flow assay strip (e.g., disposed in a diagnostic device). In some embodiments, a fluidic sample (e.g., comprising a particle-amplicon conjugate) is configured to flow through a region of the lateral flow assay strip (e.g., a test pad) comprising one or more test lines. In some embodiments, a first test line comprises a capture reagent (e.g., an immobilized antibody) configured to detect a first target nucleic acid and an opaque marking may appear if the target nucleic acid is present in the fluidic sample. The marking may have any suitable shape or pattern (e.g., one or more straight lines, curved lines, dots, squares, check marks, x marks). In certain embodiments, the lateral flow assay strip comprises one or more additional test lines. In some instances, each test line of the lateral flow assay strip is configured to detect a different target nucleic acid. In certain embodiments, the region (e.g., the test pad) of the lateral flow assay strip generating an opaque marking further comprises one or more control lines to indicate that a human (or animal) sample was successfully collected, nucleic acids from the sample were amplified, and that amplicons were transported through the lateral flow assay strip.

### III. Computer Implementation

In some embodiments, a diagnostic system comprises instructions for using a diagnostic device and/or otherwise performing a diagnostic test method. The instructions may include instructions for the use, assembly, and/or storage of the diagnostic device and any other components associated with the diagnostic system. The instructions may be provided in any form recognizable by one of ordinary skill in the art as a suitable vehicle for containing such instructions. For example, the instructions may be written or published, verbal, audible (e.g., telephonic), digital, optical, visual (e.g., videotape, DVD, etc.) or electronic communications (including Internet or web-based communications). In some embodiments, the instructions are provided as part of a software-based application. In certain cases, the application can be downloaded to a smartphone or device, and then guides a user through steps to use the diagnostic device.

An illustrative implementation of a computer system 1500 that may be used in connection with any of the embodiments of the technology described herein (e.g., such as the method of FIG. 1B) is shown in FIG. 9. The computer system 1500 includes one or more processors 1510 and one or more articles of manufacture that comprise non-transitory computer-readable storage media (e.g., memory 1520 and one or more non-volatile storage media 1530). The processor 1510 may control writing data to and reading data from the memory 1520 and the non-volatile storage device 1530 in any suitable manner, as the aspects of the technology described herein are not limited in this respect. To perform any of the functionality described herein, the processor 1510 may execute one or more processor-executable instructions stored in one or more non-transitory computer-readable storage media (e.g., the memory 1520), which may serve as non-transitory computer-readable storage media storing processor-executable instructions for execution by the processor 1510.

Computing device 1500 may also include a network input/output (I/O) interface 1540 via which the computing device may communicate with other computing devices (e.g., over a network), and may also include one or more user I/O interfaces 1550, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. For example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-discussed functions of one or more embodiments. The computer-readable medium may be transportable such that the program stored thereon can be loaded onto any computing device to implement aspects of the techniques discussed herein. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

In some embodiments, a software-based application may be connected (e.g., via a wired or wireless connection) to one or more components of a diagnostic system. In certain embodiments, for example, a heater may be controlled by a software-based application. In some cases, a user may select an appropriate heating protocol through the software-based application. In some cases, an appropriate heating protocol may be selected remotely (e.g., not by the immediate user). In some cases, the software-based application may store information (e.g., regarding temperatures used during the processing steps) from the heater.

In some embodiments, a diagnostic system comprises or is associated with software to read and/or analyze test results. In some embodiments, a device (e.g., a camera, a smartphone) is used to generate an image of a test result (e.g., one or more lines detectable on a lateral flow assay strip). In some embodiments, a user may use an electronic device (e.g., a smartphone, a tablet, a camera) to acquire an image of the visible portion of the lateral flow assay strip. In some embodiments, software running on the electronic device may be used to analyze the image (e.g., by comparing any lines or other markings that appear on the lateral flow assay strip with known patterns of markings). That result may be communicated directly to a user or to a medical professional. In some cases, the test result may be further communicated to a remote database server. In some embodiments, the remote database server stores test results as well as user information such as at least one of name, social security number, date of birth, address, phone number, email address, medical history, and medications.

It will be apparent that example aspects, as described above, may be implemented in many different forms of software, firmware, and hardware in the implementations illustrated in the figures. Further, certain portions of the implementations may be implemented as a “module” that performs one or more functions. This module may include hardware, such as a processor, an application-specific integrated circuit (ASIC), or a field-programmable gate array (FPGA), or a combination of hardware and software.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

What is claimed is:

1. A test kit system comprising:
a test kit configured to rapidly detect presence of a target nucleic acid in a human sample, including a test kit component; and
a control device configured to control at least one parameter of the test kit component.

2. The system of claim 1, wherein the control device comprises a temperature control device configured to control one or more temperatures at which a biological sample is to be processed as part of the test kit to rapidly detect presence of the target nucleic acid.

3. The system of claim 2, wherein the control device controls multiple temperatures at which multiple biological samples are to be processed.

4. The system of claim 1, wherein the test kit component comprises a consumable comprising a physical encoding of control information for the control device, wherein the control device is configured to:
receive the control information of the physical encoding; and
perform one or more actions based at least in part on the control information.

5. The system of claim 4, wherein the control information comprises information specifying the one or more actions to be performed by the control device.

6. The system of claim 5, wherein the information specifying the one or more actions comprises at least one of:
a quantity of the one or more actions; and
a first action and one or more variables associated with the first action.

7. The system of claim 6, wherein the one or more variables associated with the first action include one or more values representing at least one of a time, a temperature, volume, color, or number of repetitions.

8. The system of claim 4, wherein the control information comprises security information that specifies at least one of:
an identity of the consumable; and
a secure token associated with the consumable.

9. The system of claim 4, wherein the one or more actions include increasing and/or decreasing a temperature at which the biological sample is processed.

10. The system of claim 9, wherein the temperature is increased and/or decreased for a duration, to a set temperature, or both.

11. The system of claim 4, wherein the one or more actions include activating an indicator of the temperature control device, wherein the indicator is a light and/or a sound.

12. The system of claim 4, wherein the one or more actions comprise a sequence of actions.

13. The system of claim 4, wherein the physical encoding comprises one or more of:
an RFID tag;
one or more electrical connectors; and
a data matrix code.

14. The system of claim 13, wherein the control device receives the control information by activating the RFID tag of the physical encoding.

15. The system of claim 13, wherein the temperature control device receives the control information via physical contact with the one or more electrical connectors.

16. The system of claim 13, wherein a wireless connection is established between a portable electronic device and the temperature control device based on the data matrix code, and the temperature control device receives the control information via the wireless connection.

17. The system of claim 1, wherein the test kit component comprises a consumable comprising a test tube, a cap of the test tube, a swab, a card, or some combination thereof.

18. A test kit system comprising:
a temperature control device configured to control one or more temperatures at which a biological sample is to be processed as part of a diagnostic test to rapidly detect presence of a target nucleic acid; and
a consumable comprising an RFID tag.

19. The system of claim 18, wherein the temperature control device comprises hardware for activating the RFID tag of the consumable.

20. The system of claim 18, wherein the RFID tag encodes control information for the temperature control device.

21. The system of claim 20, wherein the temperature control device is configured to:
receive the control information of the RFID tag by activating the RFID tag; and
perform one or more actions based at least in part on the control information.

22. The system of claim 21, wherein the one or more actions comprise at least one of:
authenticating the security information;
increasing a temperature at which the biological sample is processed; or
decreasing a temperature at which the biological sample is processed.
